(19) United States
(12) Patent Application Publication
(10) Pub. No.: US 2003/0118755 A1
(43) Pub. Date: Jun. 26, 2003

(54) Filled synthetic turf with ballast layer

(76) Inventors: Joseph E. Motz, Cincinnati, OH (US); Mark A. Heinlein, Cincinnati, OH (US); Stephen L. Linville, Rydal, GA (US)

Correspondence Address: WOOD, HERRON & EVANS, LLP, 2700 CAREW TOWER, 441 VINE STREET, CINCINNATI, OH, 45202, US

(21) Appl. No.: 10/028,221

(22) Filed: Dec. 21, 2001

(51) Int. Cl. A01N 3/00

(52) U.S. Cl. 428/17

(57) ABSTRACT

A synthetic turf comprises a backing with a plurality of pile filaments secured to the backing and extending upwardly therefrom and filled with particulate fill material. The pile filaments create a grass-like appearance for the playing surface. The fill material comprises a lower ballast layer of gravel residing on the backing and an upper layer of resilient particles above the lower layer. The lower layer of gravel provides weight and stability to hold down the synthetic turf without migrating to the surface. The upper layer provides cushioning and uniform resilience for the synthetic turf.

### FIELD OF THE INVENTION

This invention relates to synthetic turfs for athletic fields and, more particularly, to a synthetic turf filled with particulate material so as to give the field stability and resiliency.

### BACKGROUND OF THE INVENTION

A natural grass turf covering has traditionally been cultivated on playing surfaces for athletic games or events. In addition to looking good, natural grass turf provides inherent resiliency and cushioning, thereby minimizing the risk of injury due to an athlete's impact with the turf. Such natural grass turf coverings have traditionally been used to cover American football or soccer fields. Many athletes participating in these high impact sports desire a surface with a high degree of resiliency such as is provided by a natural grass turf covering.

However, maintenance of natural grass turf on athletic playing areas can be expensive and time consuming. Natural grass does not grow well within shaded areas like those within indoor or partially enclosed stadiums. In addition, some “heavy traffic” locations on the playing field are susceptible to wearing out or deteriorating due to continuous or excessive wear. These worn areas may become muddy and slippery after the natural grass dies, increasing the likelihood of injury.

Therefore, various types of synthetic turf have been developed and installed on athletic playing surfaces, particularly surfaces located within indoor stadiums. Generally, these various synthetic turf surfaces reduce the expense of maintaining athletic playing surfaces and increase the durability of the turf surface. Synthetic turf generally comprises a flexible backing and a plurality of grass-like pile filaments or fibers extending upwardly from the backing. The flexible backing is typically laid on a foundation or compacted substrate, such as crushed stone or stabilized base material.

Most earlier forms of synthetic turf relied solely on the backing and the pile filaments or fibers as the playing surface. ASTROTURF synthetic turf is an example of this type of artificial turf. However, in recent years there has been a move toward synthetic turfs which look and feel more like natural grass.

To do this, the pile filaments are generally increased in length, to more closely resemble the look of natural grass. Also, in order to give the synthetic turf a desired degree of resiliency and stability, a granular fill material is placed between or among the upstanding pile filaments of the synthetic turf. This granular fill material typically extends upwardly from the upper surface of the backing to a height below the tops of the pile filaments, thereby leaving upper portions of the pile filaments exposed for aesthetic purposes, among others. The granular fill material helps maintain in a substantially upright condition the filaments of the synthetic turf.

In the past this granular fill material has been sand, crushed slag particles, resilient foam, crumb rubber particles, sand or several different combinations of two or more of these materials. The most typical of these infill materials for synthetic turfs has been sand, because it is readily available at a relatively low cost, and it provides enough weight to hold the backing down during and after installation. This hold down aspect remains important even after installation, because filled synthetic turfs are subject to large temperature fluctuations, which results in contraction and expansion of the turf backing. A fill with at least one layer of sand stabilizes the backing of the synthetic turf and provides weight to minimize lateral movement of the backing.

U.S. Pat. No. 3,995,079 discloses a filled synthetic turf for golf greens, the granular fill material being granulated coal slag, crushed flint or crushed granite. The problem with the use of these particles as a fill material is that they are very abrasive. This inherent abrasiveness increases the probability of scrapes or abrasions to persons falling upon the filled synthetic turf.

U.S. Pat. No. 4,044,179 discloses a filled synthetic turf for athletic playing surfaces, wherein the granular fill material is sand with a small amount of moisture retaining material. The problem with the use of sand as the fill is that sand compacts over time and use, resulting in a filled synthetic turf which is harder than desired. Because such playing surfaces are commonly used for high impact sports, the harder the field, the greater the likelihood of injury for the players using the field. Another problem with using sand as the fill material is that sand retains water or moisture, thereby increasing the susceptibility of the filled synthetic turf to mold or mildew.

U.S. Pat. No. 4,337,283 discloses a filled synthetic turf for athletic playing surfaces, the granular fill material being a uniformly mixed combination of sand particles and resilient particles. One inherent problem with the use of such a mixture is that, over time and after repeated use, the resilient particles of the mixture tend to migrate to the top of the fill layer, with the sand tending to settle below the resilient particles. The sand that settles to the bottom of the fill layer tends to compact over time and use. This ultimately results in a layered synthetic turf which is harder and more abrasive than desired.

A further disadvantage of an initially uniform mixture of this type is that the top surface never remains completely mixed. Inevitably the top surface will have some localized regions of abrasive sand particles. This means that the playing surface is not uniform in performance characteristics across its entire surface area. It also means that for some regions of the field, players will inevitably come into contact with the sand particles and may suffer skin abrasions.

U.S. Pat. No. 5,958,527 discloses a filled synthetic turf with an infill of sand and resilient particles which are specifically layered, in an effort to overcome the above-described problems of a uniformly mixed sand/rubber infill. More particularly, the granular fill material comprises three separate layers of particles, with sand at the bottom, resilient particles at the top and a mixture therebetween. While this may be an improvement over prior uniformly mixed infills, the improvement tends to be short-lived. Over time and after repeated use, the sand at the bottom of the mixture tends to compact, causing the field to harden and to inhibit the vertical drainage of water off the field through the backing of the filled synthetic turf.

Also, as a synthetic field is used over time, the cleats of athletes tend to churn up and mix the various fill materials. Thus, even if a layered infill is used, eventually this cleat churning will result in some abrasive sand particles finding their way to the surface of the synthetic turf between the pile filaments. This results in upper areas of exposed sand, which means the playing surface lacks uniformity. Also, whenever an athlete falls or contacts the turf, the athlete is susceptible to cuts or abrasions due to the sand. Moreover, the sand particles located at the surface of the fill material also are abrasive to the pile filaments of the synthetic turf, thereby degrading and/or fibrillating the tops of the pile filaments over time. In short, based on applicants' present understanding of filled artificial fields, for infills with a mixture of sand and resilient particles, whether uniformly mixed or layered, the resilient effect of the rubber particles is only temporary.

Therefore, it is an object of the present invention to sufficiently hold down the backing of a filled synthetic turf while eliminating the adverse effects presently associated with the use of sand.

It is another object of the present invention to extend the life of the resilient characteristics of a filled synthetic turf while still maintaining a high degree of directional stability for the synthetic backing.

It is still another object of the present invention to attain a longer lasting, uniformly resilient athletic playing surface at a relatively low cost, preferably with the playing surface being sufficiently versatile in design to accommodate a number of potential structural enhancements.

### SUMMARY OF THE INVENTION

The present invention accomplishes these objects for a filled synthetic turf by using a particulate fill comprising at least some particles other than sand, i.e. particles such as gravel, to serve as a “ballast” to hold down the backing. In one aspect of the present invention, the filled synthetic turf has a dual-layered particulate fill, including a lower layer of a heavy and relatively large particulate such as gravel, to serve as a “ballast” to hold down the backing and an upper layer of resilient particles such as rubber residing over the ballast layer.

The filled synthetic turf comprises a backing residing on a foundation; a plurality of grass-like pile filaments secured to the backing and extending generally upwardly therefrom and a particulate fill material residing on the backing. The foundation may be crushed stone, dirt, asphalt, concrete, a pad or any other supporting surface. For drainage purposes, one or more drainage members may comprise part of the foundation.

The backing is preferably a flexible, water permeable material but may be made of any desired material. The backing may be a single layer of material or multiple layers of material joined together.

A plurality of grass-like pile filaments are secured to the backing and extend generally upwardly therefrom. The pile filaments preferably comprise synthetic ribbons of a selected length. They may be made of nylon, polyethylene or a polyethylene/polypropylene blend or any other material. They may be tufted, adhesively or otherwise joined to the backing. The pile filaments are preferably dyed or colored green so as to resemble the appearance of natural grass.

The fill material resides upon the backing and extends upwardly to a desired height which is below the tops of the pile filaments. This gives the field a green appearance, resembling natural grass. In addition, the particulate fill helps to prevent the pile filaments from moving or becoming trampled down.

In one aspect of the present invention, the particulate fill material is divided into at least two layers: a first lower layer of ballast particles located on top of the backing and a second upper layer of resilient particles residing above the first lower layer. The first lower layer is comprised of particles such as gravel which provide weight for holding the backing in place. According to the United States Golf Association (U.S.G.A.), gravel is defined as particles having a diameter greater than 2 millimeters and sand is defined as particles having a diameter less than 2 millimeters. Fine gravel is defined by the U.S.G.A. as particles having a diameter between 2 and 3.4 millimeters. Although the U.S.G.A. uses diameter to measure particulate size, the particles of the present invention need not be symmetrical, i.e. have a diameter. They may be irregularly shaped. The ballast particles of the present invention are not intended to be limited to gravel. One type of ballast particle which is suitable for the present invention has the following analysis: 100 percent passing through a 0.5 inch (12 millimeter) sieve; not more than 10 percent passing through a number 10 (2 millimeter) sieve; and not more than 5 percent passing through a number 18 (1 millimeter) sieve.

The second upper layer provides resiliency for the synthetic turf. The resilient particles are preferably synthetic particles such as rubber particles, commonly referred to as crumb rubber.

In one aspect of the present invention, the height of the first lower layer is approximately equal to the height of the second upper layer. However, different circumstances for different fields, perhaps depending on the sport for which the field is primarily designated, may result in a desire or a need to have the first lower layer and the second upper layer of different desired heights. There may even be some circumstances where the particulate fill material essentially comprises a generally uniform mixture of ballast particles and resilient particles.

In one variation of the present invention, the filled synthetic turf is multi-layered comprising at least two layers of filled synthetic turf. A surface layer of filled synthetic turf, such as the one described herein, resides above a subsurface lower layer of another filled synthetic turf. The subsurface comprises a subsurface backing with a plurality of subsurface pile filaments extending upwardly therefrom to a desired height. A subsurface fill material resides on the subsurface backing to a desired vertical height relative to the desired height of the subsurface pile filaments. The subsurface fill material includes at least some resilient particles. In one aspect of the present invention the subsurface fill material may comprise gravel or sand as a lower layer and resilient particles such as rubber particles as an upper layer. The subsurface fill material may be held in place with a binder, such as a polymeric coating, applied to the subsurface fill material and the subsurface pile filaments. Other binders such as latex or urethane may be used to hold the subsurface fill material in place.

With this particular variation of the present invention, the composition of the subsurface fill material, the height of the subsurface pile filaments and/or the binder are selected to achieve a desired degree of shock absorption for the subsurface and for the upper layer of synthetic turf.

In yet another aspect of the present invention, tubing may reside in the subsurface fill material above the subsurface backing but below the tops of the subsurface pile filaments. The tubing is adapted to be operatively connected to a pump or other device to convey fluid within the tubing to selectively heat or cool the subsurface and thereby heat or cool the filled synthetic turf located above the subsurface.

The objects and features of the present invention will become more readily apparent from the following detailed description and the accompanying drawings.

### BRIEF DESCRIPTION OF THE DRAWINGS

FIG. 1 is a cross-sectional view of the filled synthetic turf of the present invention.

FIG. 1A is a cross-sectional view of the filled synthetic turf of FIG. 1 residing on a slightly different foundation.

FIG. 1B is a cross-sectional view of one aspect of the filled synthetic turf of the present invention.

FIG. 2A is a cross-sectional view of another embodiment of the present invention illustrating a filled synthetic turf residing on a subsurface comprising another filled synthetic turf.

FIG. 2B is a cross-sectional view of another embodiment of the present invention illustrating a filled synthetic turf residing on a subsurface comprising a filled synthetic turf similar to that illustrated in FIG. 1 but including a binder.

FIG. 2C is a cross-sectional view of another embodiment of the present invention illustrating the filled synthetic turf of FIG. 1 residing on a subsurface comprising another filled synthetic turf like that of FIG. 1 but including a polymeric coating.

FIG. 2D is a cross-sectional view of another embodiment of the present invention illustrating a filled synthetic turf residing on a subsurface comprising another filled synthetic turf having tubing extending therethrough.

FIG. 3A is a perspective view of an alternative embodiment of the present invention, illustrating a filled synthetic turf having tubing extending therethrough.

FIG. 3B is a perspective view of an alternative embodiment of the present invention, illustrating a filled synthetic turf being heated by a heat source via the backing of the synthetic turf.

### DETAILED DESCRIPTION OF THE PREFERRED EMBODIMENTS OF THE INVENTION

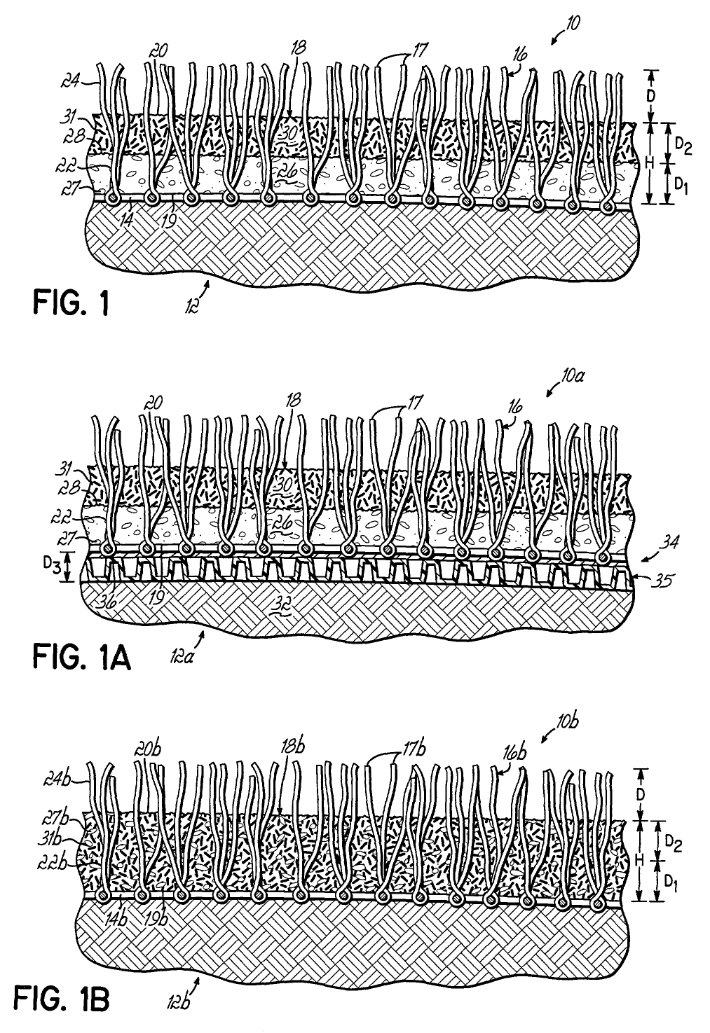

FIG. 1 illustrates a filled synthetic turf 10 incorporating the present invention. FIG. 1 illustrates the filled synthetic turf 10 resting upon a foundation 12. The foundation 12 may take any one of many known forms and may include crushed stone or the like known in the athletic playing field industry.

Referring to FIG. 1, the filled synthetic turf 10 of the present invention comprises a backing 14 residing on the foundation 12. The backing 14 is preferably made of a flexible, water permeable material but may be made of any type of material such as foam. Although FIG. 1 illustrates a single layer of backing 14, the backing 14 may comprise multiple layers joined together in any known manner.

A plurality of grass-like pile filaments 16 are secured to the backing 14 and extend generally upwardly therefrom terminating at ends 17. The pile filaments 16 comprise synthetic ribbons of a selected length and may be made of nylon, polyethylene, a polyethylene/polypropylene blend, or any other appropriate material. The pile filaments 16 may be tufted to the backing 14, glued to the backing 14, or secured to the backing in other known manner.

A particulate fill material 18 resides on the backing 14 and extends upwardly from the backing 14 to a desired height H. As illustrated in FIG. 1, the particulate fill material 18 has a lower surface 19 residing on the backing 14 and an upper surface 20 which is located a fixed distance D below the tops or ends 17 of the pile filaments 16. Thus, each of the pile filaments 16 has a lower portion 22 located inside the particulate fill material 18 and an upper portion 24 located above the particulate fill material 18. The upper portions 24 give the playing surface a green appearance or look resembling natural grass. The particulate fill material 18 helps stabilize the pile filaments 16 in place and helps prevent the pile filaments 16 from becoming trampled or run-down.

As illustrated in FIG. 1, the particulate fill material 18 is divided into at least two layers. Referring to FIG. 1, the particulate fill material 18 includes a first lower layer 26 of ballast particles 27 such as gravel located on the backing 14 and extending upwardly from the backing 14 a distance D₁ to an upper surface 28. A second upper layer 30 of resilient particles 31 rests on the upper surface 28 of the first lower layer 26. The first lower layer 26 provides weight and stability for the synthetic turf and helps hold the backing 14 in its desired location. The second upper layer 30 of resilient particles 31 such as rubber provides resiliency for the synthetic filled turf 10. The second upper layer 30 is of a height D₂ extending from the upper surface 28 of the lower layer 26 to the upper surface 20 of the particulate fill material 18.

Referring to FIG. 1A, a filled synthetic turf 10a similar to that of FIG. 1 is illustrated. However, the foundation 12a is slightly different from that illustrated in FIG. 1. The foundation 12a illustrated in FIG. 1A comprises a solid lower portion 32 and an upper portion 34 comprising at least one drainage member 35 extending upwardly from the lower portion 32 a distance D₃. The drainage member 35 is illustrated as having a plurality of indentations 36 and an upper piece 38. One type of drainage member which has been successfully used is manufactured by the Nickelon Corporation of Norcross, Ga., and sold under the trademark MIRADRI.

Referring to FIG. 1B, a filled synthetic turf 10b similar to that of FIG. 1 is illustrated. In this aspect of the present invention, the particulate fill material 18b is not divided into layers, but instead is a mixture of ballast particles such as gravel and resilient particles such as crumb rubber. The particulate fill material 18b extends upwardly from the backing 14b of the turf a height H to an upper surface 20b which is located below the tops 17b of the pile filaments 16b. The particulate fill material 18b includes a mixture of ballast particles 27b such as gravel and resilient particles 31b such as crumb rubber. Other particles may be included if desired.

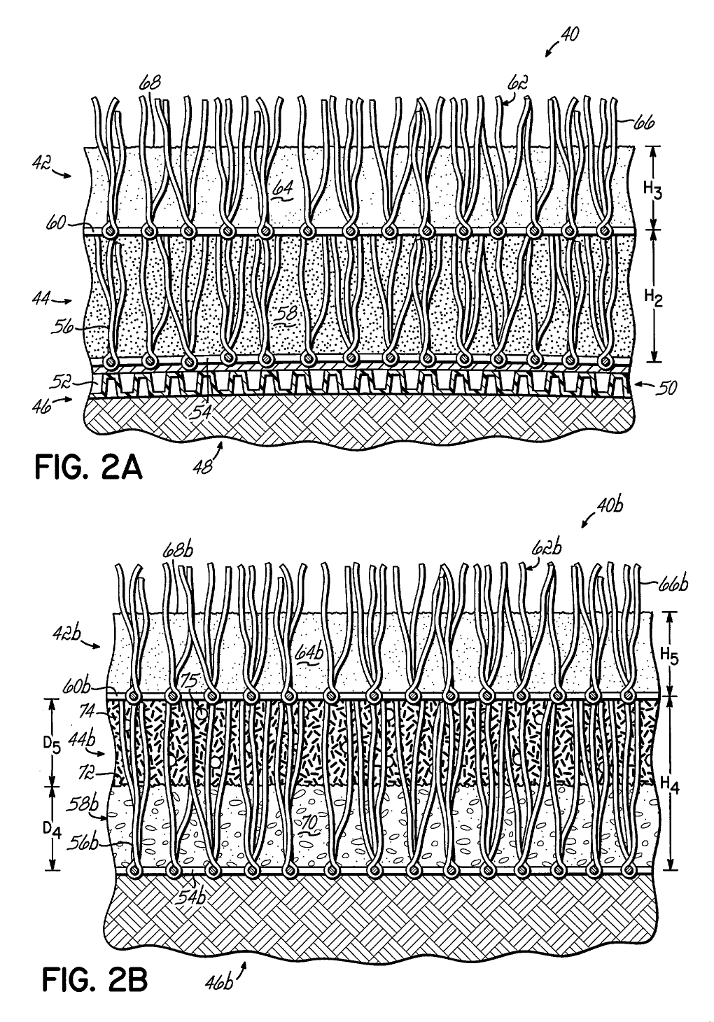

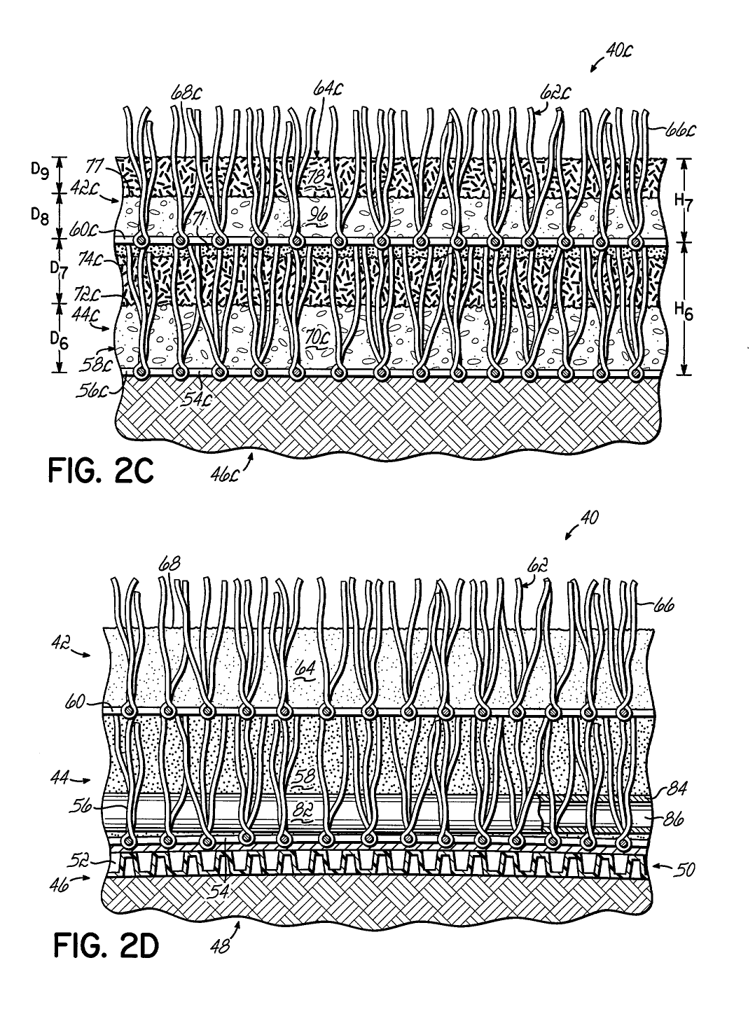

FIGS. 2A through 2D illustrate alternative aspects of the present invention in which two layers of filled synthetic turf are used for an athletic playing surface. Although two layers of filled synthetic turf are illustrated and described, any number of layers of filled synthetic turf may be used in accordance with the present invention.

FIG. 2A illustrates a filled synthetic turf 40 having an upper surface layer 42 of filled synthetic turf and a lower subsurface layer 44 resting on a foundation 46 and located below the upper surface layer 42 of filled synthetic turf. The foundation 46 comprises a lower portion 48 which is illustrated as being a solid member, but may be crushed stone or any other suitable foundation, and an upper portion 50 which may be one or more drainage members as described hereinabove and illustrated in FIG. 1A. Alternatively, the foundation 46 may be uniform like the foundation 12 illustrated in FIG. 1.

Directly above the foundation 46 is the subsurface layer 44 comprising a subsurface backing 54 having a plurality of subsurface pile filaments 56 secured thereto and extending upwardly therefrom to a desired height H₂. The subsurface pile filaments 56 may be tufted or secured in any known manner to the subsurface backing 54. A subsurface fill material 58 resides on the subsurface backing 54 and extends upwardly a distance equal to the height H₂ of the subsurface pile filaments 56. However, the height of the subsurface fill material 58 may be any desired height. The subsurface particulate fill material 58 is illustrated as being a homogenous material. However, the subsurface particulate fill material 58 may be layered, a mixture or homogenous with any known or desired particulate fill material.

Referring the FIG. 2A, the surface layer 42 comprises a filled synthetic turf having a surface backing 60 residing on the top of the subsurface layer 44. In addition, a plurality of surface pile filaments 62 are tufted or otherwise secured to the surface backing 60 in any known manner. A surface particulate fill 64 resides on the surface backing 60 to a desired vertical height H₃. In the embodiment illustrated in FIG. 2A, the surface particulate fill 64 is a homogenous material including at least some resilient particles such as crumb rubber. However, the surface particulate fill 64 may be any known particles. Each of the surface pile filaments 62 have an upper portion 66 extending above an upper surface 68 of the surface particulate fill 64.

In order to achieve a desired degree of shock absorption, the subsurface layer 44 and more particularly the subsurface pile filaments 56 may be of any desired height. The greater the desired degree of shock absorption, the greater the height of the subsurface layer 44. In addition, the composition of the subsurface particulate fill material may be modified to obtain the desired degree of shock absorption.

FIG. 2B illustrates an alternative embodiment or aspect of the present invention. For the sake of simplicity, this embodiment will utilize the same numbers for corresponding elements as the embodiment illustrated in FIG. 2A, but with a “b” designation after the appropriate numeral.

FIG. 2B illustrates another multi-layered filled synthetic turf 40b comprising an upper surface layer 42b of filled synthetic turf and a lower subsurface layer 44b of filled synthetic turf resting on a foundation 46b. The foundation 46b is illustrated as being a uniform member, but may have multiple layers which may include one or more drainage members as described and illustrated hereinabove.

Directly above the foundation 46b is the subsurface layer 44b comprising a subsurface backing 54b having a plurality of subsurface pile filaments 56b secured thereto and extending upwardly therefrom to a desired height H₄. The subsurface pile filaments 56b may be tufted or secured in any known manner to the subsurface backing 54b. A subsurface fill material 58b resides on the subsurface backing 54 and extends upwardly a distance equal to the height H₄ of the subsurface pile filaments 56b. The subsurface fill material 58b includes a first lower layer 70 of gravel located on the subsurface backing 54b and extending upwardly from the backing 54b a distance D₄ to an upper surface 72. A second upper layer 74 of resilient particles rests on the upper surface 72 of the first lower layer 70. The first lower layer 70 provides weight and stability for the subsurface layer and helps hold the subsurface backing 54b in its desired location. The second upper layer 74 of resilient particles such as rubber provides resiliency for the upper layer of synthetic filled turf. The second upper layer 74 is of a height D₅ extending from the upper surface 72 of the lower layer 70 to the tops of the subsurface pile filaments 56b.

In order to hold the subsurface fill material 58b in place, a binder 75 is located in the subsurface fill material. The binder 75 is illustrated in FIG. 2B as particles located throughout the second upper layer 74c of the subsurface fill material 58b. The binder 75 may be pellets of latex or a polyethylene which are activated by water, heat or any other known method. Alternatively, the binder 75 may be layered on top of the subsurface fill material as illustrated in FIG. 2C.

Referring the FIG. 2B, the surface layer 42b comprises a filled synthetic turf having a surface backing 60b residing on the top of the subsurface layer 44b. In addition, a plurality of surface pile filaments 62b are tufted or otherwise secured to the backing 60b in any known manner and extend upwardly therefrom to a desired height. A surface particulate fill 64b resides on the surface backing 60b to a desired vertical height H₅. The surface pile filaments 62b each have an upper portion 66b extending above an upper surface 68b of the surface particulate fill 64b. In the embodiment illustrated in FIG. 2B the surface particulate fill 64b is a homogenous material. including at least some resilient particles such as crumb rubber. However, the surface particulate fill 64b may be layered with any known or desired particles, preferably including at least some resilient particles for shock absorption.

In order to achieve a desired degree of shock absorption, the subsurface layer 44b may be of any desired height and the subsurface particulate fill 58b may be of any desired material.

FIG. 2C illustrates an alternative embodiment of the present invention. For the sake of simplicity, this embodiment will utilize the same numbers for corresponding elements as the embodiments illustrated in FIGS. 2A and 2B but with a “c” designation after the appropriate numeral.

FIG. 2C illustrates a multi-layered filled synthetic turf 40c comprising a foundation 46c, a lower subsurface layer 44c of filled synthetic turf resting on the foundation 46c and an upper surface layer 42c of filled synthetic turf. The foundation 46c is illustrated as being a uniform member, but may have multiple layers which may include one or more drainage members as described and illustrated hereinabove.

Directly above the foundation 46c is the subsurface layer 44c of filled synthetic turf comprising a subsurface backing 54c having a plurality of subsurface pile filaments 56c secured thereto and extending upwardly therefrom to a desired height H₆. The subsurface pile filaments 56c may be tufted or secured in any known manner to the subsurface backing 54c. A subsurface fill material 58c resides on the subsurface backing 54c and preferably extends upwardly a distance equal to the height H₆ of the subsurface pile filaments 56c. The subsurface fill material 58c includes a first lower layer 70c of gravel located on the subsurface backing 54c and extending upwardly from the backing 54c a distance D₆ to an upper surface 72c of the first lower layer 70c. A second upper layer 74c of resilient particles rests on the upper surface 72c of the first lower layer 70c. The first lower layer 70c provides weight and stability for the subsurface layer and helps hold the subsurface backing 54c in its desired location. The second upper layer 74c of resilient particles such as rubber provides resiliency for the upper layer of synthetic filled turf. The second upper layer 74c is of a height D₇ extending from the upper surface 72c of the lower layer 70c to the tops of the subsurface pile filaments 56c.

In order to hold the subsurface fill material in place, a binder 71 is layered on top of the subsurface fill material. The binder 71 is illustrated in FIG. 2C as a polymeric coating layer located on top of the second upper layer 74c of the subsurface fill material. The polymeric coating layer may be a urethane sprayed or otherwise applied to the top of the subsurface fill material. However, the binder 71 may be applied using other known methods. Alternatively, the binder 75 may be located throughout the subsurface fill material as illustrated in FIG. 2B.

Referring the FIG. 2C, the surface layer 42c comprises a filled synthetic turf having a surface backing 60c residing on the top of the subsurface layer 44c. In addition, a plurality of surface pile filaments 62c are tufted or otherwise secured to the backing 60c in any known manner. A surface particulate fill 64c resides on the surface backing 60b to a desired vertical height H₇. The surface pile filaments 62c each have an upper portion 66c extending above an upper surface 68c of the surface particulate fill 64c.

The surface particulate fill 64c is illustrated in FIG. 2C as a having two layers, a lower layer 76 and an upper layer 78. However, the surface particulate fill 64c may comprise any number of layers of fill or be homogenous material as illustrated in FIG. 2B. The surface fill material 64c includes a first lower layer 76 of gravel located on the surface backing 60c and extending upwardly from the surface backing 60c a distance D₈ to an upper surface 77. A second upper layer 78 of resilient particles rests on the upper surface 77 of the first lower layer 76. The first lower layer 76 provides weight and stability for the subsurface layer and helps hold the surface backing 60c in its desired location. The second upper layer 78 of resilient particles such as rubber provides resiliency for the upper layer 42c of synthetic filled turf. The second upper layer 78 is of a height D₉ extending from the upper surface 77 of the lower layer 76 to an upper surface 68c spaced below the tops of the surface pile filaments 62c.

In order to achieve a desired degree of shock absorption, the subsurface layer 44c may be of any desired height and the subsurface particulate fill 58c may be of any desired material.

FIG. 2D illustrates the multi-layered filled synthetic turf illustrated in FIG. 2A. In addition, hollow tubing 82 extends through the subsurface layer 44. The tubing 82 comprises an exterior wall 84 having a hollow interior 86 such that fluid (not shown) may flow through the tubing 82. The tubing 82 resides within the subsurface fill material above the subsurface backing and below the tops of the subsurface pile filaments. The tubing 82 is adapted to be operatively connected to a pump to convey fluid through the tubing 82 to selectively heat or cool the subsurface, thereby heating or cooling the surface layer 42 of the mult-layered filled synthetic turf.

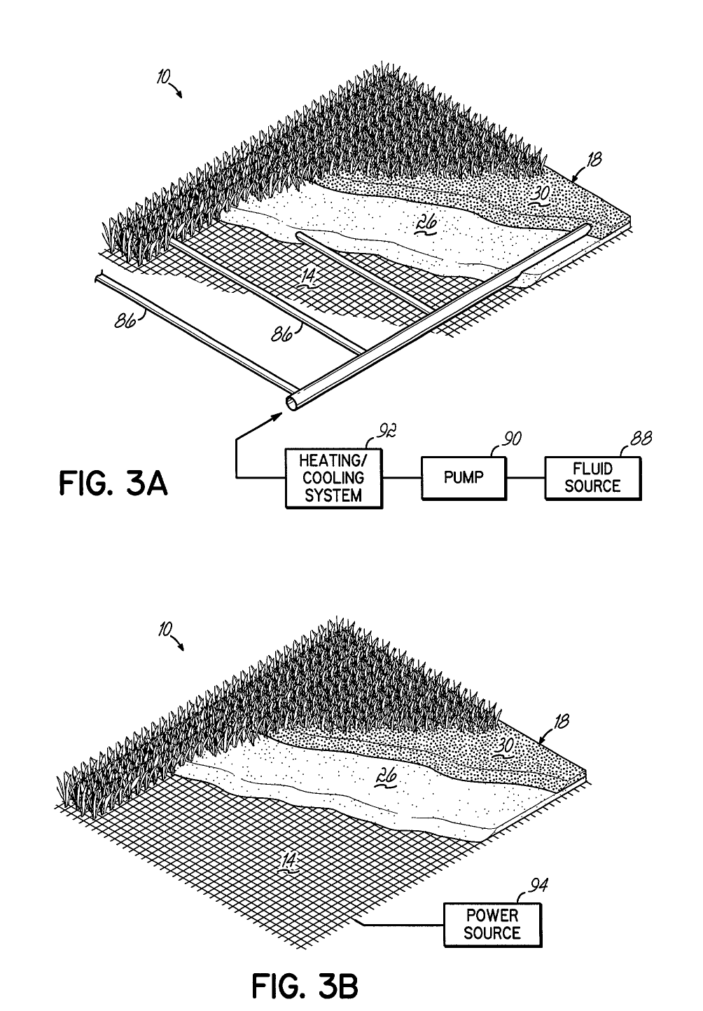

FIG. 3A illustrates yet another aspect of the present invention. In this embodiment of the present invention, any filled synthetic turf may be heated or cooled. FIG. 3A illustrates the filled synthetic turf of FIG. 1 having two layers of particulate fill material. For the sake of simplicity, the numerals used to describe the embodiment illustrated in FIG. 1 are repeated. Multiple interconnected tubes 86 are operatively connected to a fluid source 88 which contains water or air, for example. A pump 90 or other suitable structure conveys or forces fluid (not shown) from the fluid source 88 into the tubes 86. A heating/cooling system 92 heats or cools the fluid to the appropriate temperature. Although the tubes 86 are illustrated as being in one configuration or arrangement, they may assume any desired configuration, such as a serpentine configuration.

The tubes 86 are illustrated as passing through the first lower layer 26 of gravel within the particulate fill material 18. However, the tubes 86 may pass through the upper layer 30 of resilient particles or through both layers, if desired. Alternatively, if a homogenous particulate fill material is used rather than a layered particulate fill material, the tubes may be located at any desired depth therein.

FIG. 3B illustrates yet another aspect of the present invention. In this embodiment of the present invention, any filled synthetic turf may be heated. FIG. 3B illustrates the filled synthetic turf of FIG. 1 having two layers of particulate fill material. For the sake of simplicity, the numerals used to describe the embodiment illustrated in FIG. 1 are repeated. To heat the filled synthetic turf 10, the backing 14 is operatively connected to a power source 94 which supplies energy to heat the backing 14. This method of heating the filled synthetic turf may be used with any type of synthetic turf having a backing, regarding of the particulate fill material.

In use, unfilled synthetic turf is unrolled in strips on a foundation where the athletic playing surface is to be located. The strips are preferably 8 feet in width but may be any desired width. Adjacent strips are sewn or joined together along the longitudinal edges thereof using any conventional means. More particularly, the backing of the synthetic turf is placed on the foundation and/or a drainage member. The pile filaments are moved or urged into a generally vertical orientation extending upwardly from the backing.

The particulate fill material is then placed on the backing to a desired vertical height. The pile filaments of the synthetic turf extend above the upper surface of the fill material. The particulate fill material is applied in layers. The first lower layer of gravel is first located on the backing in a quantity sufficient to extend upwardly from the backing to a desired height. The second upper layer of resilient particles is then located on top of the first lower layer of gravel in a quantity sufficient to extend upwardly from the first lower layer to a desired height.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

We claim:

1. A filled synthetic turf comprising:
a foundation;
a backing residing on the foundation;
a plurality of grass-like pile filaments secured to the backing and extending generally upwardly therefrom; and
a particulate fill material residing on the backing to a desired height, the pile filaments extending above the fill material, the fill material including,
a first lower layer of gravel located on the backing and a second upper layer of resilient particles, wherein the first lower layer provides weight for holding down the backing and the second upper layer provides resiliency for the synthetic turf.

2. The filled synthetic turf of claim 1 wherein the pile filaments comprise synthetic ribbons of selected length.

3. The filled synthetic turf of claim 1 wherein the first lower layer comprises pea gravel.

4. The filled synthetic turf of claim 1 wherein the second upper layer comprises synthetic particles.

5. The filled synthetic turf of claim 4 wherein the synthetic particles are rubber.

6. The filled synthetic turf of claim 1 wherein the height of the first lower layer is about equal to the height of the second upper layer.

7. The filled synthetic turf of claim 1 and further comprising:
a subsurface residing between the foundation and the backing, the subsurface including:
a subsurface backing with a plurality of subsurface pile filaments extending upwardly therefrom to a desired height;
a subsurface fill material residing on the subsurface backing to a desired vertical level relative to the desired height of the subsurface pile filaments including at least some resilient particles; and
a polymeric coating applied to the subsurface fill material and the subsurface pile filaments to hold the subsurface fill material in place.

8. The filled synthetic turf of claim 7 wherein the composition of the subsurface fill material and the desired height of the subsurface pile filaments are selected to achieve a desired degree of shock absorption for the subsurface and for the synthetic turf located thereabove.

9. The filled synthetic turf of claim 7 wherein subsurface fill material includes gravel in combination with the resilient particles.

10. The filled synthetic turf of claim 7 wherein the subsurface further comprises:
tubing residing within the subsurface fill material above the subsurface backing and below the tops of the subsurface pile filaments, the tubing being adapted to convey fluid within the tubing to selectively heat or cool the subsurface, to thereby heat or cool the filled synthetic turf.

11. The filled synthetic turf of claim 1 wherein said backing residing on the foundation is water permeable.

12. A filled synthetic turf comprising:
a foundation;
a drainage member residing on the foundation;
a water permeable backing residing on the drainage member;
a plurality of grass-like pile filaments secured to the backing and extending generally upwardly therefrom; and
a particulate fill material residing on the backing to a desired height, the pile filaments extending above the fill material, the fill material including,
a first lower layer of gravel located on the backing and a second upper layer of resilient particles, wherein the first lower layer provides weight for holding the backing and the second upper layer provides resiliency for the synthetic turf.

13. The filled synthetic turf of claim 12 wherein said pile filaments are grass-like fibers.

14. The filled synthetic turf of claim 12 wherein said gravel comprises particles having a diameter greater than 2 milimeters.

15. A filled synthetic turf comprising:
a foundation;
a backing residing on the foundation;
a plurality of grass-like pile filaments secured to the backing and extending generally upwardly therefrom; and
a particulate fill material residing on the backing to a desired height, the pile filaments extending above the fill material, the fill material including gravel and resilient particles, wherein the gravel provides weight for holding the backing in place and the resilient particles provide resiliency for the synthetic turf.

16. A filled synthetic turf comprising:
a foundation;
a backing residing on the foundation;
a plurality of pile filaments secured to the backing and extending generally upwardly therefrom; and
a particulate fill material residing on the backing to a desired height, the pile filaments extending above the fill material, the fill material including,
a first lower layer of particles having a diameter greater than 2 millimeters located on the backing and a second upper layer of resilient particles, wherein the first lower layer provides weight for holding the backing and the second upper layer provides resiliency for the synthetic turf.

17. A method of constructing a filled synthetic turf on a foundation, comprising:
placing a backing on the foundation, a plurality of pile filaments being secured to the backing and extending generally upwardly therefrom; and
filling a particulate fill material on the backing to a desired height, the pile filaments extending above the fill material, the fill material including a first lower layer of gravel located on the backing and a second upper layer of resilient particles, wherein the first lower layer provides weight for holding the backing on the foundation and the second upper layer provides resiliency for the synthetic turf.

18. A method of constructing a filled synthetic turf on a foundation, comprising:
placing a drainage member on the foundation,
placing a water permeable backing upon the foundation, a plurality of pile filaments being secured to the backing and extending generally upwardly therefrom; and
filling a particulate fill material on the backing to a desired height, the pile filaments extending above the fill material, the fill material including a first lower layer of gravel located on the backing and a second upper layer of resilient particles, wherein the first lower layer provides weight for holding the backing on the foundation and the second upper layer provides resiliency for the synthetic turf.
